(19) United States
(12) Patent Application Publication
(10) Pub. No.: US 2012/0158824 A1
(43) Pub. Date: Jun. 21, 2012

(54) APPARATUS AND METHOD FOR DISTRIBUTED PROCESSING OF RADIO FREQUENCY IDENTIFICATION (RFID) MIDDLEWARE

(75) Inventor: Sang Yeol PARK, Cheju (KR)

(73) Assignee: Java Information Technology Ltd., Cheju (KR)

(21) Appl. No.: 12/972,129

(22) Filed: Dec. 17, 2010

(51) Int. Cl. G06F 15/16

(52) U.S. Cl. 709/203

(57) ABSTRACT

Provided is an apparatus and a method for a distributed processing of a radio frequency identification (RFID) middleware. An apparatus for a distributed processing of a RFID middleware includes a user/manager interface for inputting an event; a web application processor for displaying and managing a content corresponding to the event submitted from the user/manager interface; a load information processor for selecting an optimal one of distributed middleware servers according to scheduling of the web application processor; and a server process manager for managing each of the distributed middleware servers in a cluster by interworking with the user/manager interface. According to the embodiments, it is possible to continuously cope with the extension of the system and the infra, and the system can be stably maintained. Thus, considerable economic benefits can be achieved.

### BACKGROUND

Embodiments relate to an apparatus and a method for a distributed processing of a radio frequency identification (RFID) middleware. More particularly, embodiments relate to an apparatus and a method for a distributed processing of a RFID middleware including a plurality of RFID servers connected in a parallel manner and a separate devide managing the plurality of the RFID servers in order to process huge amounts of data.

A RFID technology is a contactless automative identification technology. In the RFID technology, a product identification information is stored to a RFID tag with a very small size, and the information of the product and the environment information is sended to the network by an antenna and a reader through radio frequency. Also, the RFID technology is a promising technology leading an information technology (IT) market from the human-oriented IT to the object-oriented IT. In addition, the RFID technology has can be applied to various fields by changing frequency bands. For example, the RFID technology may be applied to an information technology, logistics, supply chain, transporiton, environment, security. Thus, the RFID technology is a next generation core technology.

The RFID technology is regarded as a core technology for realizing ubiquitous computing. A middleware, which acts as a bridge between the product where the RFID tag is attached and an application service, is necessary so that a developer of the application service can easily build various ubiquitous application services. The RFID middleware manages various sensors, collects data by using various protocols, extracts the valuable information and the information available to the application service from the collected and non-processed data, and forwards them to the application service.

As the application range of the RFID and USN(ubiquitous sensor network) technology is extended by the expansion of the ubiquitous computing environment, the studies and the developments are being carried out in order to minimize the bottleneck phenomenon and the delay time and to process the huge amounts of the data. In the RFID system used at the large warehouse, several readers regularly monitor severals RFID tags, and the readers form Ad-Hoc network with a wireless and forward the information to a RFID database.

In this system, the collision of the readers and the collision of the tags, and the load balancing of the FRID readers may be issued. In the RFID system processing the huge amounts of the data, when the identification of the several readers is performed, the identification regions of the readers may be overlapped. According to a recent study, it was found that the load balancing between the readers can reduce the delay time of the identification of the tag and decrease the energy consumption of the readers.

Additionally, in the RFID system processing the huge amounts of the data, the studies for the load balancing method between the RFID middlewares are being carried out in order to resolve the problem of a concentration of the load to the RFID middlewares, along with the studies to the load balancing methods between the readers. The RFID middlewares in the RFID middleware system play an essential role to be capable of exchanging data between a group of the readers and an upper application layer. In the load balancing of the RFID middleware, resouces are distributed according to a status of the resources and a load status of nodes in order to equally distribute the load, so that the resources can be effectively used and the high performance can be achieved. If the load concentration of the RFID middleware lasts, the efficiency in processing may become lower, and the delay and the failure of business flows may be generated by the process delay. In order to prevent the concentration of the load to the specific node, it is necessary to introduce the load distributing process.

### SUMMARY

Embodiments provide an apparatus and a method for a distributed processing of a RFID middleware including a cluster with a plurality of RFID servers connected in a parallel manner and a separate devide managing the plurality of the RFID servers in the cluster in order to process huge amounts of data.

Embodiments also provide an apparatus and a method for a distributed processing of a RFID middleware being capable of managing a load information, a process, and a resource of a RFID middleware server.

In one embodiment, an apparatus for a distributed processing of a radio frequency identification (RFID) middleware includes a user/manager interface for inputting an event; a web application processor for displaying and managing a content corresponding to the event submitted from the user/manager interface; a load-information processor for selecting an optimal one of distributed middleware servers according to scheduling of the web application processor; and a server process manager for managing each of the distributed middleware servers in a cluster by interworking with the user/manager interface.

The load-information processor may include a server load manager for receiving and storing a current load information from the distributed middleware servers; a load information manager for analyzing and managing a request specifaction sended from the web application processor; a weight processor for changing an algorithm depending on a weight information analyzed by the load information manager and for recalculating the load information according to the changed algorithm; and a dispatcher controller for deciding a schedule to send the request specification to the distributed middleware servers.

The server process manager may include a middleware processor for managing a setup of a process and a thread according to the request specification sended from the dispatcher controller; a user instruction processor for interpreting a predefined instruction for the distributed middleware servers; and a middleware server resource manager for updating the load information of the distributed middleware server changed by the user instruction processor and the middleware processor and for managing a resource of the distributed middleware servers.

The event may include at least one of a data collection cycle, a data cleaning condition, and the load information of the distributed middleware servers.

The web application processor may control a schedule, and include a specification backup manager for storing all the processed results.

The load information manager may analyze at least one of a content of the data processed by the distributed middleware server and a content of the load information where the weight is applied.

The weight processor may decide the weight by using at elast one of a data collection time, a data collection period, a response time, a number of readers, and a number of processes.

The cluster may include a plurality of distributed middleware servers.

The setup of the thread may include at least one of a start of the thread, an end of the thread, a stop of the thread, and a restart of the thread.

The setup of the process and the thread may be automatically performed.

The setup of the process and the thread may be performed by an instruction from the outside.

In another emdodiment, a method for a distributed processing of a radio frequency identification middleware including submitting a request specification for a web application; updating a load information of distributed middleware servers in a cluster; analyzing the request specification; determining whether a weight exists or not; making a dispatcher massage when the weight does not exist; sending the request specification to the optimal one of the distributed middleware servers selected based on the dispatcher massage; forwarding a result information for the sending to a user; analyzing and managing a process and a thread according to the request specification; determining whether a separate instruction for managing the distributed middleware server exists or not; and sending a result according to the request specification to the outside when the separate instruction does not exist.

When the weight exists, the method may include changing an algorithm according to the weight; and recalculating the load information by the changed algorithm.

When the separate instruction exists, the method may include analyzing the separate instruction; executing a process according to an instruction of a setup of a process through the analyzed instruction; updating the current information of the load and the process; and sending the updated information.

The setup of the process may include at least one of a start of the process, an end of the process, a stop of the process, and a restart of the process.

### BRIEF DESCRIPTION OF THE DRAWINGS

FIG. 1 illustrates an apparatus for a distributed processing of a radio frequency identification (RFID) middleware according to an embodiment of the present invention.

FIG. 2 illustrates a load-information processor of FIG. 1.

FIG. 3 illustrates a server process manager of FIG. 1.

FIG. 4 is a flow chart illustrating a method for a distributed processing of a RFID middleware according to an embodiment of the present invention.

### DETAILED DESCRIPTION OF THE EMBODIMENTS

Hereinafter, an apparatus and a method for a distributed processing of a radio frequency identification (RFID) middleware will be described with reference to the accompanying drawings.

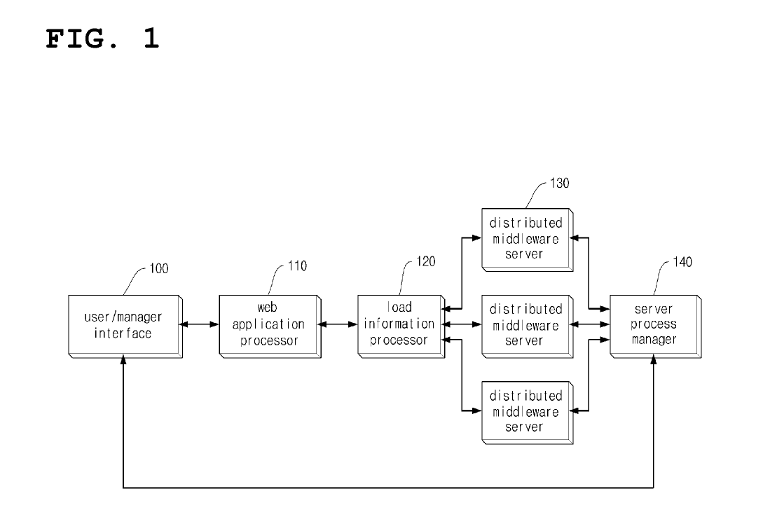

FIG. 1 illustrates an apparatus for a distributed processing of a RFID middleware according to an embodiment of the present invention. As shown in FIG. 1, the apparatus includes a user/manager interface 100, a web application processor 110, a load-information processor 120, distributed middleware servers 130, and a server process manager 140.

The user/manager interface 100 is an interface where the user and/or the manger input a specific request. The user and/or manager may input various factors through the user/manager interface 100 for monitoring and managing a content related to a data collection (such as a data collection cycle or a data cleaning condition), a load information of the distributed middleware servers 130, and a process and a thread of each of the distributed middleware servers 130.

The web application processor 110 displays and manages a content corresponding to the predefined specification submitted by the user/manager interface 100. The web application processor 110 mainly controls the input and the output of the request and response specifications, and the schedulce regarding the input and output. The web application processor 110 includes a specification backup manager for storing all the processed results to a database.

The load information processor 120 analyzes the request specifaction sended according to the schedule of the web application processor 110, and selects an optimal one of the distributed middleware servers 130 through a load balancing of distributed middleware serbers 130.

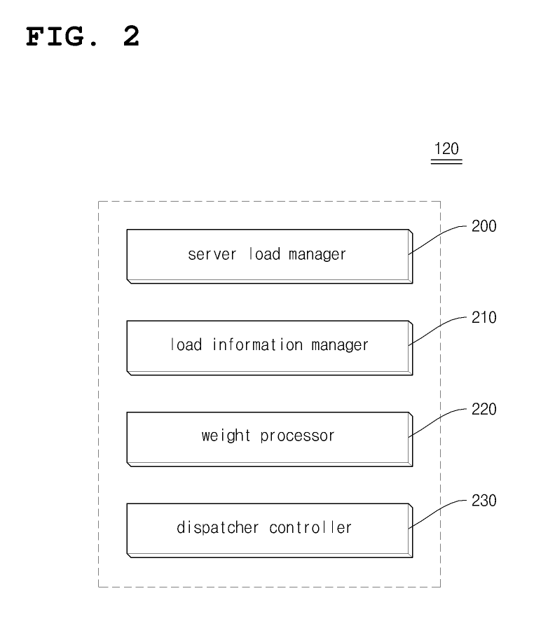

FIG. 2 illustrates the load information processor 120 of FIG. 1. As shown in FIG. 2, the load information processor 120 includes a server load manager 200 for distributed middleware servers, a load information manager 210, a weight processor 220, and a dispatcher controller 230.

The server load manager 200 receives a current load information from the distributed middleware servers 130 connected to the load information processor 120, generates a table, and stores the same. The load information of the distributed middleware servers 130 is dynamically updated by changing algorithm according to the analysis result of the request specification sended from the web application processor 110. However, the method changing the load information is not limited thereto, and various method changing the load information can be applied.

The load information manager 210 analyzes and manages the request specifiction sended from the web application processor 110. The anaysis result may be classified in two informations. The first one relates to the date to be processed by the middleware (such as, an ECspec(event cycle specification) of ALE(application level events)-compliant middleware). The second one relates to the load information where the weight is applied. The load information with the weight (the weight information) is for recalculating the load information table generated by the server load manager 200 based on standards of the request specification and for updating the same. For example, when it is assumed that the server load manager 200 calculates the load information of the distributed middleware servers 130 by standby processes, one process having data collection time of ten minutes and ten readers exists at an A middleware server, and two processes (each process data collection time of three minutes and five readers) exist at a B middleware server. Then, the load information of the A and B middleware servers is changed according to the data collection time, the number of the readers, the number of the processes, etc. That is, the weight information determines which whether is selected.

The weight processor 220 changes an algorithm depending on the weight information analyzed by the load information manager 210 and recalculates the load information according to the changed algorithm. The weight processor 220 selects an algorithm depending on various weights such as a data collection cycle, a data cleaning condition, a response time, a number of the readers, a number of the process, etc. Also, depending on the selected algorithm, the weight processor 220 updates the load information of the distributed middleware servers 130 that the server load manager 200 manages, and stores the updated load information to the table.

The dispatcher controller 230 decides a schedule for sending the request specification to the distributed middleware servers 130. The dispatcher controller 230 makes a massage including the updated load information of the distributed middleware servers 130 containing the request specification, and decides an optimal one of the distributed middleware servers 130 based on the massage.

The distributed middleware servers 130 may include ALE(application level events)-compliant RFID middleware. The distributed middleware servers 130 can process various type codes including the EPC code. At the middleware servers 130, a plurality of the individual RFID middlewares consist a cluster. The load information processor 120 manages the load information of the cluster as a unit.

The server process manager 140 manages each of distributed middleware servers 130 in the cluster by interworking with the user/manager interface 100.

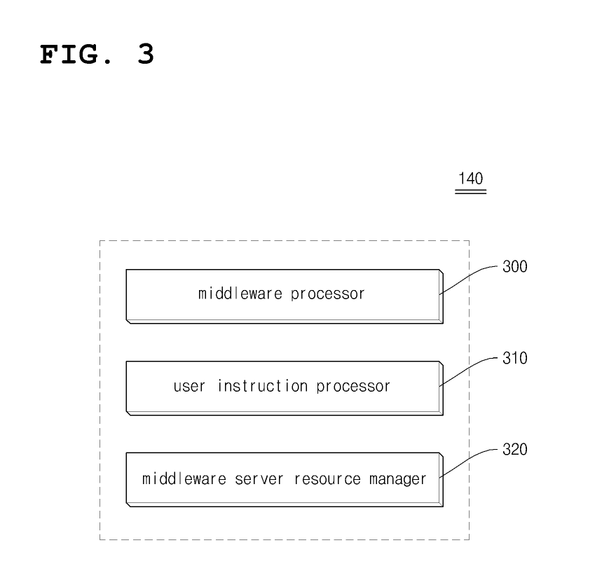

FIG. 3 illustrates the server process manager 140 of FIG. 1. As shown FIG. 3, the server process manager 140 includes a middleware processor 300, a user instruction processor 310, and a middleware server resource manager 320.

The middleware processor 300 manages a setup of a process and a thread according to the request specification sended from the dispatcher controller 230. The setup of the thread includes a start of the thread, an end of the thread, a stop of the thread, or a restart of the thread. The setup of the process and the thread may be performed by a separate instruction from the user or be automatically performed. The ALE-compliant RFID middleware receives ECReports as a result, by using various processes (such as, a define process to register the ECSpec where the user/manager specify the process conditions, a pool process, an immediate process, and a subscribe process requesting the process). For example, the subscribe instruction, requesting the result on a cycle during the process specified at the ECSpec registed at the middleware, can be stopped by a separate unsubscribe instruction as a release instruction.

The user instruction processor 310 interprets a predefined instruction for the distributed middleware servers 130 in order to process huge amounts of data. When the user and the manager instructs for a processe of the individual one of the distributed middleware servers 130 and/or for the start/end/stop/restart of the thread or the application program, the user instruction processor 310 interprets and executes the instruction, updates the load information of the distributed middleware servers 130, and sends the result.

The middleware server resource manager 320 updates the load information of the distributed middleware servers 130 changed by the user instruction processor 310 and the middleware processor 300, and manages a resource of the distributed middleware servers 130.

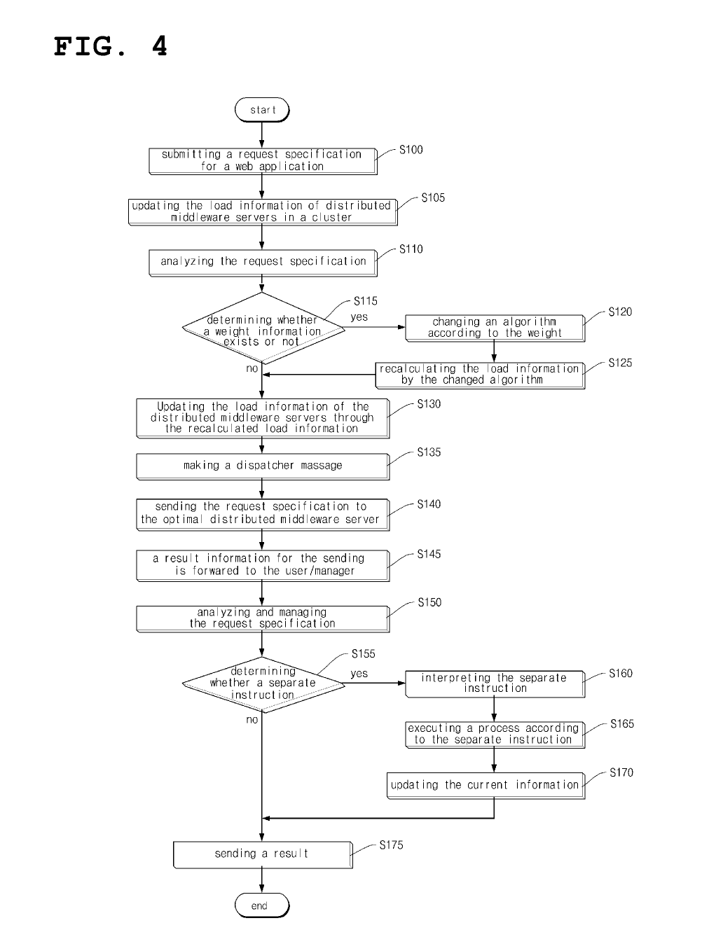

FIG. 4 is a flow chart illustrating a method for a distributed processing of a RFID middleware according to an embodiment of the present invention. As shown in FIG. 4, a request specification for a web application is submitted (S100). The user/manager interface 100 submits the request specification to the web application processor 110. This request specification is sended to the load information processor 120.

The load information of the distributed middleware servers 130 in the cluster is updated (S105). The load information of the distributed middleware servers 130 in the cluster is updated through the server load manager 200 of the load information processor 120.

The request specification is analyzed (S110) through the load information manager 210 of the load information processor 120.

It is determined whether a separate weight information exists at the analyzed request specification or not (S115).

When the weight exists, an algorithm is changed according to the weight (S120). The algorithm is changed according to the weight through the weight processor 220 of the load information processor 120.

The load information is recalculated by the changed algorithm (S125).

The load information of the distributed middleware servers 130 is updated through the recalculated load information (S130).

The dispatcher massage is made so that the insturcion can be performed at the dispatcher (S135). The dispatcher controller 230 makes the dispatcher massage, based on the updated load information of the distributed middleware servers 130, so that the insturcion can be performed at the dispatcher.

An optimal one of the distributed middleware servers 130 is selected based on the dispatcher massage, the request specification is sended to the optimal one of the distributed middleware servers 130 (S140).

A result information for the sending is forwared to the user/manager (S145).

The distributed middleware server 130, where the load information is sended, analyzes and manages the process and the thread according to the request specification (S150).

It is determined whether a separate instruction for managing the distributed middleware servers 130 exists or not (S155). The sever-processing manager 140 determines whether the separate instruction for managing the individual distributed middleware server 130, which input by the user/manager interface 100, exists or not, except for the sended load information.

When the separate instruction exists, the separate instruction is interpreted (S160). The user instruction processor 310 of the server process manager 140 interprets the instruction of the user.

The instruction such as the start/end/stop/restart of a process is executed through the analyzed instruction (S165).

The current information of the load and the process based on the instruction is updated (S170).

The updated information is sended (S175). The middleware server resource manager 320 of the server process manager 140 updates the middleware server resource manage information, and the server load manager 200 of the load information processor 120.

The distributed middleware server 130 sends the result according to the request specification to the user/manager (S180).

According to the embodiment, it is possible to continuously cope with the extension of the system and the infra, and the system can be stably maintained. Thus, considerable economic benefits can be achieved.

Although embodiments have been described with reference to a number of illustrative embodiments thereof, it should be understood that numerous other modifications and embodiments can be devised by those skilled in the art that will fall within the spirit and scope of the principles of this disclosure.

What is claimed is:

1. An apparatus for a distributed processing of a radio frequency identification (RFID) middleware, comprising:
a user/manager interface for inputting an event;
a web application processor for displaying and managing a content corresponding to the event submitted from the user/manager interface;
a load information processor for selecting an optimal one of distributed middleware servers according to scheduling of the web application processor; and
a server process manager for managing each of the distributed middleware servers in a cluster by interworking with the user/manager interface.

2. The apparatus of claim 1, wherein the load information processor comprises:
a server load manager for receiving and storing a current load information from the distributed middleware servers;
a load information manager for analyzing and managing a request specifiction sended from the web application processor;
a weight processor for changing an algorithm depending on a weight information analyzed by the load information manager and for recalculating the load information according to the changed algorithm; and
a dispatcher controller for deciding a schedule to send the request specification to the distributed middleware servers.

3. The apparatus of claim 2, wherein the server process manager comprises:
a middleware processor for managing a setup of a process and a thread according to the request specification sended from the dispatcher controller;
a user instruction processor for interpreting a predefined instruction for the distributed middleware servers; and
a middleware server resource manager for updating the load information of the distributed middleware server changed by the user instruction processor and the middleware processor, and for managing a resource of the distributed middleware servers.

4. The apparatus of claim 3, wherein the event comprises at least one of a data collection cycle, a data cleaning condition, and the load information of the distributed middleware servers.

5. The apparatus of claim 3, wherein the web application processor controls a schedule, and comprises a specification backup manager for storing all the processed results.

6. The apparatus of claim 3, wherein the load information manager analyzes at least one of a content of the data processed by the distributed middleware server and a content of the load information where the weight is applied.

7. The apparatus of claim 3, wherein the weight processor decides the weight by using at elast one of a data collection time, a data collection period, a response time, a number of readers, and a number of processes.

8. The apparatus of claim 3, wherein the cluster comprises a plurality of distributed middleware servers.

9. The apparatus of claim 3, wherein the setup of the thread comprises at least one of a start of the thread, an end of the thread, a stop of the thread, and a restart of the thread.

10. The apparatus of claim 3, wherein the setup of the process and the thread is automatically performed.

11. The apparatus of claim 3, wherein the setup of the process and the thread is performed by an instruction from the outside.

12. A method for a distributed processing of a radio frequency identification (RFID) middleware, comprising:
submitting a request specification for a web application;
updating a load information of distributed middleware servers in a cluster;
analyzing the request specification;
determining whether a weight exists or not;
making a dispatcher massage when the weight does not exist;
sending the request specification to the optimal one of the distributed middleware servers selected based on the dispatcher massage;
forwarding a result information for the sending to a user;
analyzing and managing a process and a thread according to the request specification;
determining whether a separate instruction for managing the distributed middleware server exists or not; and
sending a result according to the request specification to the outside when the separate instruction does not exist.

13. The method of claim 12, when the weight exists, comprising:
changing an algorithm according to the weight; and
recalculating the load information by the changed algorithm.

14. The method of claim 13, when the separate instruction exists, comprising:
analyzing the separate instruction;
executing a process according to the analyzed instruction;
updating the current information of the load and the process; and
sending the updated information.

15. The method of claim 14, wherein the setup of the process comprises at least one of a start of the process, an end of the process, a stop of the process, and a restart of the process.
